(19) United States
(12) Patent Application Publication
(10) Pub. No.: US 2026/0052342 A1
(43) Pub. Date: Feb. 19, 2026

(54) METHOD AND SYSTEM FOR MANAGING SPEAKER DAMAGE IN ELECTRONIC DEVICE

(71) Applicant: SAMSUNG ELECTRONICS CO., LTD., Suwon-si (KR)

(72) Inventors: Rishabh GUPTA, Bengaluru (IN); Raj Narayana GADDE, Bengaluru (IN)

(73) Assignee: SAMSUNG ELECTRONICS CO., LTD., Suwon-si (KR)

(21) Appl. No.: 19/370,256

(22) Filed: Oct. 27, 2025

Related U.S. Application Data
(63) Continuation of application No. PCT/KR2025/001514, filed on Jan. 24, 2025.

(30) Foreign Application Priority Data
Mar. 12, 2024 (IN) 202441017808

(51) Int. Cl. H04R 3/00; H04R 3/04

(52) U.S. Cl. CPC H04R 3/007; H04R 3/04

(57) ABSTRACT

Provided is a system and method for managing speaker damage in an electronic device. The method includes: extracting a plurality of audio feature signatures from a plurality of audio signals, wherein the plurality of audio feature signatures are extracted prior to a playback of the plurality of audio signals by the electronic device; identifying a regular microspeaker distortion and an irregular microspeaker distortion from the plurality of audio feature signatures, wherein the regular microspeaker distortion and the irregular microspeaker distortion are capable of causing one or more damageable or audibly distorted audio movements associated with one or more membranes of a speaker of the electronic device if output by the speaker; and generating a corrected audio signal for the playback by filtering the regular and the irregular microspeaker distortions from the plurality of audio feature signatures.

### CROSS-REFERENCE TO RELATED APPLICATIONS

This application is a by-pass continuation of International Application No. PCT/KR2025/001514, filed in the Korean Intellectual Property Receiving Office on Jan. 24, 2025, which claims priority to Indian Patent Application number 202441017808, filed in the Indian Intellectual Property Office on Mar. 12, 2024, the disclosures of each of which are incorporated by reference herein in their entireties.

### BACKGROUND

### 1. Field

The present disclosure relates to the field of audio processing, and more specifically, to a method and a system for managing speaker damage in an electronic device.

### 2. Description of Related Art

In an example case in which a high-quality speaker is used in a conference room for audio presentations and meetings, the electrical input is provided by an audio source, such as a microphone or a sound system output, delivering the spoken content and presentation materials as the electrical audio signal to the speaker. The voice coil within the speaker responds to the electrical audio signal by creating mechanical vibrations. The vibrations drive the speaker membrane to move back and forth, effectively translating the electrical audio signal into physical movement. As a result, the speaker membrane displaces air molecules, generating the sound waves that propagate through the conference room.

For example, a high-performance subwoofer may be used to reproduce deep bass frequencies in a music studio. The non-linear operation of the subwoofer is essential for generating powerful and resonant low-frequency sounds that enrich the audio experience, contributing to the overall depth and impact of the music. However, when the subwoofer is driven at high volume levels to produce intense bass, the non-linear operation/behavior of the speaker may lead to audible distortion, compromising the fidelity and clarity of the reproduced sound. Additionally, prolonged operation at such high levels without adequate excursion control can result in mechanical stress and potential mechanical damage to the subwoofer's cone membrane, thus impacting its long-term performance and reliability.

Excursion control in a speaker involves the implementation of measures to manage and restrict the movement of the cone membrane within its designated range of motion. The excursion control mechanism is crucial for preventing over-excursion, which can lead to distortion, mechanical stress/damage, and compromised sound quality, particularly at high volume levels or when reproducing low-frequency sounds. Speaker manufacturers use various techniques to control excursion, such as using specially designed suspension systems, limiting the power supplied to the speaker, and employing signal processing methods to prevent excessive cone membrane movement. Overall, the excursion control is essential for maintaining the integrity and longevity of the speaker while ensuring consistent and accurate sound reproduction.

Related art methods have explored the use of micro-speaker protection mechanisms for electronic devices (e.g., smartphones). Speaker mode is utilized in such electronic devices to deliver immersive multimedia experiences, including music, movies, video calling, podcasts, and games, to individual users or multiple users for shared experiences. However, the power efficiency of a typical micro-speaker is below 1%. Additionally, due to their small size, micro-speaker membranes are often over-excursed to achieve higher sound power output and improve bass response, resulting in non-linear operation. This non-linear operation can cause audio signal distortion in the short term and cause damage to the micro-speaker in the long term.

Related art methods may employ an adaptive non-linear excursion control mechanism, typically relying on current-voltage (I-V) sensing as inputs for loudspeaker models. The loudspeaker models are based on the physical characteristics of the loudspeaker as it operates in both linear and non-linear operations/modes. Such adaptive non-linear excursion control mechanisms are designed to limit speaker excursion to predefined threshold values, allowing for linear and mild non-linear operation. However, related art methods have several major disadvantages. Firstly, the related art methods often utilize current/voltage sensing hardware to estimate speaker displacement, requiring hardware sensing and making model accuracy dependent on hardware sensing sensitivity. Secondly, the loudspeaker mechanisms used to estimate speaker displacement involve numerous theoretical assumptions about micro-speaker characteristics and are challenging to implement and tune. Thirdly, the related art methods focus solely on speaker protection and often degrade audio quality in terms of loudness, bass, and timbre. Finally, the related art methods only account for mild non-linearities, as excursion level limits to thresholds cannot reduce audible distortions caused by irregular non-linearities resulting from manufacturing defects at higher excursion levels. Moreover, the related art methods use complex models that are difficult to implement and tune, have limited accuracy due to the challenge of estimating physical model parameters, cannot correct irregular distortions missed by manufacturing quality checks, and are unable to remove irregular audio distortions such as rub and buzz.

Thus, it is desired to address the above-mentioned disadvantages or other shortcomings or at least provide a useful alternative for managing speaker damage in the electronic device.

### SUMMARY

According to an aspect of the disclosure, a method for managing speaker damage in an electronic device, includes: extracting a plurality of audio feature signatures from a plurality of audio signals, wherein the plurality of audio feature signatures are extracted prior to a playback of the plurality of audio signals by the electronic device; identifying a regular microspeaker distortion and an irregular microspeaker distortion from the plurality of audio feature signatures, wherein the regular microspeaker distortion and the irregular microspeaker distortion are capable of causing one or more damageable or audibly distorted audio movements associated with one or more membranes of a speaker of the electronic device if output by the speaker; and generating a corrected audio signal for the playback by filtering the regular and the irregular microspeaker distortions from the plurality of audio feature signatures.

The extracting the plurality of audio feature signatures from the plurality of audio signals may further include: determining one or more characteristics of each of the plurality of audio signals, wherein the one or more characteristics of each of the plurality of audio signals comprises at least one of a stationary signal, a quasi-stationary signal, or a transient signal; segmenting, based on the one or more characteristics, the plurality of audio signals; and extracting, using at least one of a transformation mechanism, a type of transformation, a filter-bank mechanism, or a neural network based dimensionality reduction mechanism, the plurality of audio feature signatures from each segment, wherein the plurality of audio feature signatures comprises at least one of a power spectrum density, a root mean square (RMS) value, or a peak value of a signal.

The identifying the regular microspeaker distortion and the irregular microspeaker distortion from the plurality of audio feature signatures may include: comparing the plurality of audio feature signatures with a plurality of reference audio feature signatures, wherein the plurality of reference audio feature signatures are previously extracted from one or more audio signals that are free from the regular microspeaker distortion and the irregular microspeaker distortion; and based on the result of the comparing, determining whether the plurality of audio feature signatures includes the regular microspeaker distortion and the irregular microspeaker distortion, wherein the comparing is performed using a model trained using at least one of measured excursion data or measured acoustic data.

The method may further include: determining one or more parameters associated with the electronic device, wherein the one or more parameters comprise at least one of application characteristic information, target audio application information, audio content information, processing capability information, or available computational resource information; and selecting, based on the one or more parameters, a neural network based mechanism or a digital signal processing (DSP) based mechanism to perform the identifying the regular microspeaker distortion and the irregular microspeaker distortion.

The generating the corrected audio signal for the playback may further include: performing, based on the regular microspeaker distortion and the irregular microspeaker distortion, waveform correction on the plurality of audio signals by utilizing at least one of an equalization filter based modification mechanism, a neural network based modification mechanism, or a stochastic based processing mechanism; and generating, based on the waveform correction, the corrected audio signal for the playback.

The method may further include: determining a maximum speaker displacement value associated with the plurality of audio signals using a regression model; and improving an accuracy of at least one of the equalization filter based modification mechanism, the neural network based modification and the stochastic based processing mechanism based on the maximum speaker displacement value.

The extracting the plurality of audio feature signatures may further include: determining one or more characteristics of each of the plurality of audio signals, wherein the one or more characteristics of each of the plurality of audio signals comprises at least one of a stationary signal, a quasi-stationary signal, or a transient signal; segmenting the plurality of audio signals based on the one or more characteristics of each of the plurality of audio signals; extracting, using at least one of a transformation mechanism, a filter-bank mechanism, or a neural network based dimensionality reduction mechanism, the plurality of audio feature signatures from each of the plurality of audio signals, wherein the plurality of audio feature signatures comprises at least one of a power spectrum density, a root mean square value, or a peak value; comparing the plurality of audio feature signatures from each of the plurality of audio signals with the a plurality of reference audio feature signatures, wherein the plurality of reference audio feature signatures are previously extracted from one or more audio signals that are free from the regular microspeaker distortion and the irregular microspeaker distortion; based on the result of the comparison, determining one or more probability scores and one or more confidence intervals; validating the one or more probability scores and the one or more confidence intervals using manually labeled data, and based on a result of validation, selecting a feature extraction method.

The may further include performing at least one of: extracting, from the plurality of audio signals, one or more signal segments that cause the regular microspeaker distortion and the irregular microspeaker distortion, or extracting the plurality of audio feature signatures that cause the regular microspeaker distortion and the irregular microspeaker distortion.

The method may further include: training a regular neural network module, based on the regular microspeaker distortion and target audio data without the regular microspeaker distortion, to generate a first control signal feature, and training an irregular neural network module, based on the irregular microspeaker distortion and target audio data without the irregular microspeaker distortion, to generate a second control signal feature.

According to an aspect of the disclosure, a system for managing speaker damage in an electronic device includes: memory storing one or more instructions; a communicator; a speaker; a microphone; and at least one processor configured to execute the one or more instructions, wherein the one or more instructions, when executed by the at least one processor, cause the system to: extract a plurality of audio feature signatures from a plurality of audio signals, wherein the plurality of audio feature signatures are extracted prior to a playback of the plurality of audio signals, identify a regular microspeaker distortion and an irregular microspeaker distortion from the plurality of audio feature signatures, wherein the regular microspeaker distortion and the irregular microspeaker distortion are capable of causing one or more damageable or audibly distorted audio movements associated with one or more membranes of the speaker if output by the speaker, and generate a corrected audio signal for the playback by filtering the regular and the irregular microspeaker distortions from the plurality of audio feature signatures.

The one or more instructions, when executed by the at least one processor, may cause the system to extract the plurality of audio feature signatures from the plurality of audio signals by: determining one or more characteristics of each of the plurality of audio signals, wherein the one or more characteristics of each of the plurality of audio signals comprises at least one of a stationary signal, a quasi-stationary signal, or a transient signal, segmenting, based on the one or more characteristics, the plurality of audio signals, and extracting, using at least one of a transformation mechanism, a type of transformation, a filter-bank mechanism, or a neural network based dimensionality reduction mechanism, the plurality of audio feature signatures from each segment, wherein the plurality of audio feature signatures comprises at least one of a power spectrum density, a root mean square (RMS) value, or a peak value of a signal.

The one or more instructions, when executed by the at least one processor, cause the system to identify the regular microspeaker distortion and the irregular microspeaker distortion from the plurality of audio feature signatures by: comparing the plurality of audio feature signatures from a current segment with a plurality of reference audio feature signatures, wherein the plurality of reference audio feature signatures are previously extracted from one or more audio signals that are free from the regular microspeaker distortion and the irregular microspeaker distortion, and based on the result of the comparison, determining whether the plurality of audio feature signatures includes the regular microspeaker distortion and the irregular microspeaker distortion, wherein the comparing is performed using a model trained using at least one of measured excursion data or measured acoustic data.

The one or more instructions, when executed by the at least one processor, cause the system to: determine one or more parameters associated with the electronic device, wherein the one or more parameters comprise at least one of application characteristic information, target audio application information, audio content information, processing capability information, or available computational resource information, and select, based on the one or more parameters, a neural network based mechanism or a digital signal processing based mechanism to perform the identifying of the regular microspeaker distortion and the irregular microspeaker distortion.

The one or more instructions, when executed by the at least one processor, cause the system to generate the corrected audio signal for the playback by: performing, based on the regular microspeaker distortion and the irregular microspeaker distortion, waveform correction on the plurality of audio signals by utilizing at least one of an equalization filter based modification mechanism, a neural network based modification mechanism, or a stochastic based processing mechanism, and generating, based on the waveform correction, the corrected audio signal for the playback.

According to an aspect of the disclosure, a non-transitory computer readable medium having instructions stored therein, which when executed by at least one processor, cause the at least one processor to execute a method for managing speaker damage in an electronic device, where the method includes: extracting a plurality of audio feature signatures from a plurality of audio signals, wherein the plurality of audio feature signatures are extracted prior to a playback of the plurality of audio signals by the electronic device; identifying a regular microspeaker distortion and an irregular microspeaker distortion from the plurality of audio feature signatures, wherein the regular microspeaker distortion and the irregular microspeaker distortion are capable of causing one or more damageable or audibly distorted audio movements associated with one or more membranes of a speaker of the electronic device if output by the speaker; and generating a corrected audio signal for the playback by filtering the regular and the irregular microspeaker distortions from the plurality of audio feature signatures.

With regard to the method executed based on the instructions stored in the non-transitory computer readable medium, the extracting the plurality of audio feature signatures from the plurality of audio signals may further include: determining one or more characteristics of each of the plurality of audio signals, wherein the one or more characteristics of each of the plurality of audio signals comprises at least one of a stationary signal, a quasi-stationary signal, or a transient signal; segmenting, based on the one or more characteristics, the plurality of audio signals; and extracting, using at least one of a transformation mechanism, a type of transformation, a filter-bank mechanism, or a neural network based dimensionality reduction mechanism, the plurality of audio feature signatures from each segment, wherein the plurality of audio feature signatures comprises at least one of a power spectrum density, a root mean square value, or a peak value of a signal.

With regard to the method executed based on the instructions stored in the non-transitory computer readable medium, the identifying the regular microspeaker distortion and the irregular microspeaker distortion from the plurality of audio feature signatures includes: comparing the plurality of audio feature signatures with a plurality of reference audio feature signatures, wherein the plurality of reference audio feature signatures are previously extracted from one or more audio signals that are free from the regular microspeaker distortion and the irregular microspeaker distortion; and based on the result of the comparison, determining whether the plurality of audio feature signatures includes the regular microspeaker distortion and the irregular microspeaker distortion, wherein the comparing is performed using a model trained using at least one of measured excursion data or measured acoustic data.

With regard to the method executed based on the instructions stored in the non-transitory computer readable medium, the extracting the plurality of audio feature signatures may further include: determining one or more characteristics of each of the plurality of audio signals, wherein the one or more characteristics of each of the plurality of audio signals comprises at least one of a stationary signal, a quasi-stationary signal, or a transient signal; segmenting the plurality of audio signals based on the one or more characteristics of each of the plurality of audio signals; extracting, using at least one of a transformation mechanism, a filter-bank mechanism, or a neural network based dimensionality reduction mechanism, the plurality of audio feature signatures from each of the plurality of audio signals, wherein the plurality of audio feature signatures comprises at least one of a power spectrum density, a root mean square (RMS) value, or a peak value; comparing the plurality of audio feature signatures from each of the plurality of audio signals with the a plurality of reference audio feature signatures, wherein the plurality of reference audio feature signatures are previously extracted from one or more audio signals that are free from the regular microspeaker distortion and the irregular microspeaker distortion; based on the result of the comparison, determining one or more probability scores and one or more confidence intervals; validating the one or more probability scores and the one or more confidence intervals using manually labeled data, and based on a result of validation, selecting a feature extraction method.

With regard to the method executed based on the instructions stored in the non-transitory computer readable medium, the method may further include performing at least one of: extracting, from the plurality of audio signals, one or more signal segments that cause the regular microspeaker distortion and the irregular microspeaker distortion, or extracting the plurality of audio feature signatures that cause the regular microspeaker distortion and the irregular microspeaker distortion.

With regard to the method executed based on the instructions stored in the non-transitory computer readable medium, the method may further include: training a regular neural network module, based on the regular microspeaker distortion and target audio data without the regular microspeaker distortion, to generate a first control signal feature, and training an irregular neural network module, based on the irregular microspeaker distortion and target audio data without the irregular microspeaker distortion, to generate a second control signal feature.

This foregoing summary is provided to introduce a selection of concepts, in a simplified format, that are further described in the following detailed description. This summary is neither intended to identify key or essential concepts of the disclosure, nor is it intended for determining the scope of the disclosure.

To further clarify the aspects and features of the present disclosure, a more particular description will be rendered by reference to specific embodiments thereof, which are illustrated in the appended drawings. It is appreciated that these drawings depict only typical embodiments of the disclosure and are therefore not to be considered limiting of its scope.

### BRIEF DESCRIPTION OF THE DRAWINGS

The above and other aspects, features, and advantages of certain embodiments of the present disclosure will be more apparent from the following description taken in conjunction with the accompanying drawings, in which:

FIGS. 1A and 1B are diagrams illustrating one or more operations associated with a loudspeaker, according to the related art;

FIG. 2 illustrates a block diagram of an electronic device for managing speaker damage, according to an embodiment;

FIG. 3 illustrates a scenario where the electronic device utilizes a neural network (NN) based mechanism to generate one or more corrected audio signals for playback, according to one or more embodiments;

FIG. 4 illustrates a scenario where the electronic device utilizes the NN-based mechanism and real-time prediction of maximum excursion to generate the one or more corrected audio signals for the playback, according to one or more embodiments;

FIG. 5 illustrates a scenario where the electronic device utilizes a digital signal processing (DSP) based mechanism to generate one or more corrected audio signals for playback, according to one or more embodiments;

FIG. 6 illustrates a scenario where the electronic device utilizes the DSP-based mechanism and real-time prediction of maximum excursion to generate the one or more corrected audio signals for the playback, according to one or more embodiments;

FIGS. 7A and 7B illustrate one or more example scenarios involving the training and evolution of the NN to generate the one or more corrected audio signals for the playback, according to one or more embodiments;

FIG. 8 is a flow diagram illustrating a method for managing the speaker damage, according to one or more embodiments; and

FIG. 9 is a flow diagram illustrating a method for managing the speaker damage, according to another embodiment.

Further, skilled artisans will appreciate that elements in the drawings are illustrated for simplicity and may not have necessarily been drawn to scale. For example, the flow charts illustrate the method in terms of the most prominent operations involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

For the purpose of promoting an understanding of the principles of the present disclosure, reference will now be made to one or more embodiments illustrated in the drawings, and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory of the disclosure and are not intended to be restrictive thereof.

Reference throughout this specification to “an aspect”, “another aspect” or similar language means that a particular feature, structure, or characteristic described in connection with the embodiment is included in one or more embodiments of the present disclosure. Thus, appearances of the phrase “in an embodiment”, “in one embodiment”, “in another embodiment”, “in one or more embodiments” and similar language throughout this specification may, but do not necessarily, all refer to the same embodiment.

The terms “include”, “including”, “comprise”, “comprising”, or any other variations thereof, are intended to cover a non-exclusive inclusion, such that a process or method that comprises a list of operations does not include only those operations but may include other operations not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The embodiments disclosed herein, and the various features and advantageous details thereof, are explained more fully with reference to one or more non-limiting embodiments that are illustrated in the accompanying drawings and detailed in the following description. Descriptions of well-known components and processing techniques are omitted so as to not unnecessarily obscure the embodiments herein. Also, the one or more embodiments described herein are not necessarily mutually exclusive, as some embodiments can be combined with one or more other embodiments to form new embodiments. The term “or” as used herein, refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

It will be understood that when an element is referred to as being “connected” with or to another element, it can be directly or indirectly connected to the other element, wherein the indirect connection includes “connection via a wireless communication network”.

Throughout the description, when a member is “on” another member, this includes not only when the member is in contact with the other member, but also when there is another member between the two members.

As used herein, the expressions “at least one of a, b or c” and “at least one of a, b and c” indicate “only a,” “only b,” “only c,” “both a and b,” “both a and c,” “both b and c,” and “all of a, b, and c.”

As used herein, the singular forms “a,” “an” and “the” are intended to include the plural forms as well, unless the context clearly indicates otherwise.

With regard to any method or process described herein, an identification code may be used for the convenience of the description but is not intended to illustrate the order of each step or operation. Each step or operation may be implemented in an order different from the illustrated order unless the context clearly indicates otherwise. One or more steps or operations may be omitted unless the context of the disclosure clearly indicates otherwise.

As is traditional in the field, embodiments may be described and illustrated in terms of blocks that carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help understand various technical features and it should be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another. In the following description, like reference numerals refer to like elements throughout the specification.

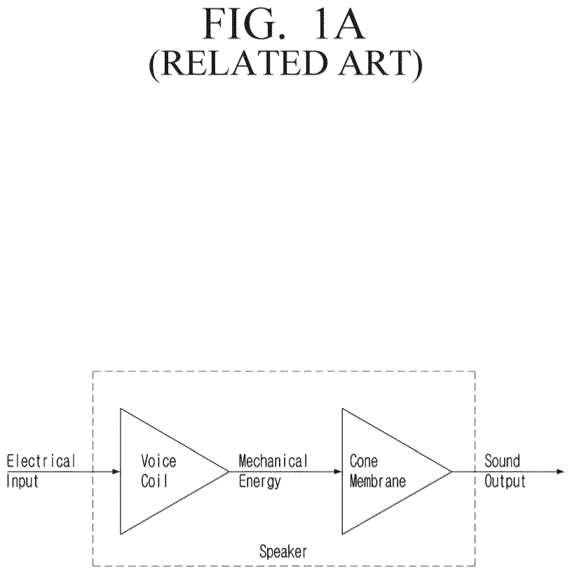

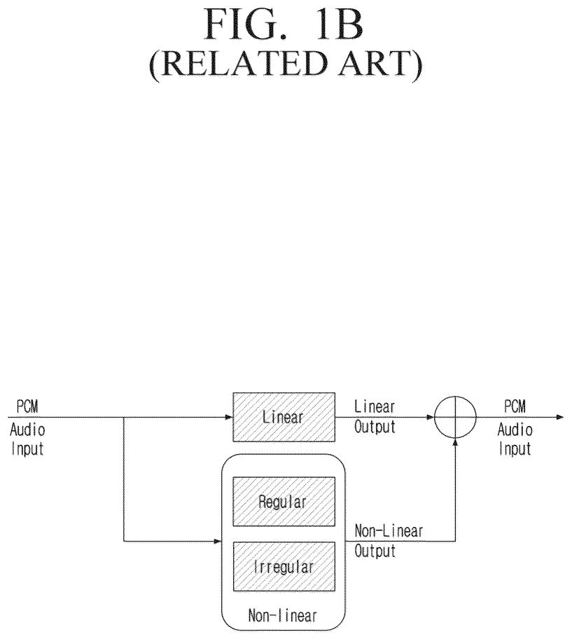

FIGS. 1A and 1B illustrate one or more operations associated with a loudspeaker, according to the related art.

A loudspeaker, also known as a speaker, is an electroacoustic transducer that converts an electrical audio signal (electrical input) into a sound output, as illustrated in FIG. 1A. The speaker consists of several key components that work together to produce the sound output. The electrical input is the audio signal that is fed into the speaker, typically in the form of an alternating current (AC) voltage. The electrical input is then used to drive a voice coil, which is a coiled wire attached to a diaphragm (cone membrane) that moves back and forth in response to the electrical input. The mechanical energy generated by the voice coil's movement causes the cone membrane to vibrate, producing the sound output (sound waves). A speaker membrane, also known as the cone membrane, is a crucial part of the speaker. Its functionality involves converting the mechanical energy from the voice coil into physical movements, resulting in the displacement of air molecules and the generation of the sound waves. The speaker membrane's ability to accurately reproduce the physical movements directly impacts the fidelity and quality of the sound output produced by the speaker.

Additionally, speaker operation can be characterized as a combination of a linear operation, a regular non-linear operation, and an irregular non-linear operation, as illustrated in FIG. 1B. The linear operation refers to the speaker's response to a small electrical input, where the movement of the cone membrane is directly proportional to the input signals (electrical input). The regular non-linear operation occurs when the speaker responds to moderate input signals, causing the cone membrane's movement to exhibit non-linear behavior within predictable limits. The irregular non-linear operation takes place when the speaker is subjected to large input signals, resulting in unpredictable and non-linear behavior of the cone membrane. The non-linear operation (e.g., regular non-linear operation, irregular non-linear operation) is a critical aspect of the speaker's functionality as it is essential for producing the bass frequencies and high sound pressure levels necessary to achieve superior audio quality. However, the non-linear operation can result in audible distortion and potential mechanical damage to the speaker components.

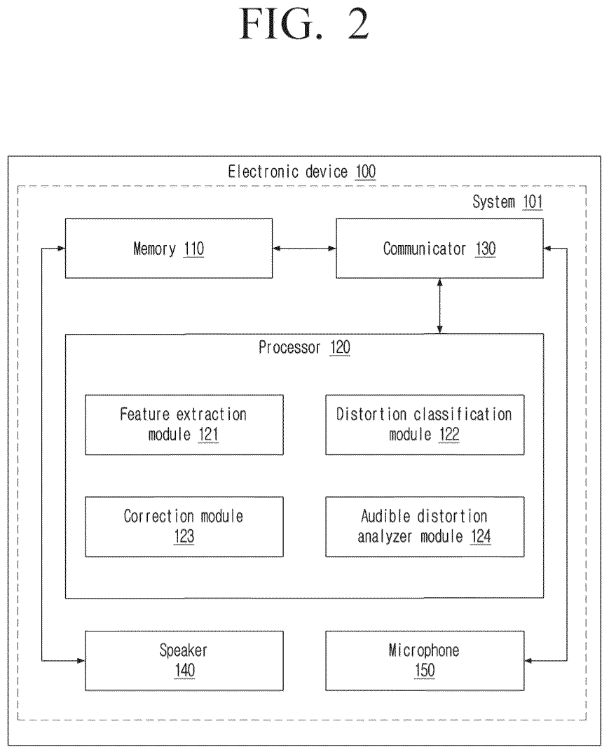

Referring now to the drawings, and more particularly to FIGS. 2 through 9, where similar reference characters denote corresponding features consistently throughout the figures, there are shown example embodiments.

FIG. 2 illustrates a block diagram of an electronic device 100 for managing speaker damage, according to an embodiment. Examples of the electronic device 100 may include, but are not limited to, a smartphone, a tablet computer, a personal digital assistance (PDA), an internet of things (IoT) device, a wearable device, a smartwatch, a Bluetooth speaker, a headphone, a head mounted device, an earphone, a gaming console, a home security device, a car audio device, a portable audio device, etc.

In an embodiment, the electronic device 100 comprises a system 101. The system 101 may include a memory 110, a processor 120, a communicator 130, a speaker 140, and a microphone 150. In one or more embodiments, the system 101 may be implemented on one or more electronic devices.

In an embodiment, the memory 110 stores instructions to be executed by the processor 120 for managing speaker damage in the electronic device 100, as discussed throughout the disclosure. The memory 110 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 110 may, in some examples, be considered a non-transitory storage medium. The term “non-transitory” may indicate that the storage medium is not embodied in a carrier wave or a propagated signal. However, the term “non-transitory” should not be interpreted to mean that the memory 110 is non-movable. In some examples, the memory 110 can be configured to store larger amounts of information than the memory. In certain examples, a non-transitory storage medium may store data that can, over time, change (e.g., in Random Access Memory (RAM) or cache). The memory 110 can be an internal storage unit, or it can be an external storage unit of the electronic device 100, a cloud storage, or any other type of external storage.

The processor 120 communicates with the memory 110, the communicator 130, the speaker 140, and the microphone 150. The processor 120 is configured to execute instructions stored in the memory 110 and to perform various processes for managing speaker damage in the electronic device 100, as discussed throughout the disclosure. The processor 120 may include one or a plurality of processors, and may be a general-purpose processor, such as a central processing unit (CPU), an application processor (AP), or the like, a graphics-only processing unit such as a graphics processing unit (GPU), a visual processing unit (VPU), and/or an artificial intelligence (AI) dedicated processor such as a neural processing unit (NPU).

The processor 120 is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

In one or more embodiments, the processor 120 may include a feature extraction module 121, a distortion classification module 122, a correction module 123, and an audible distortion analyzer module 124.

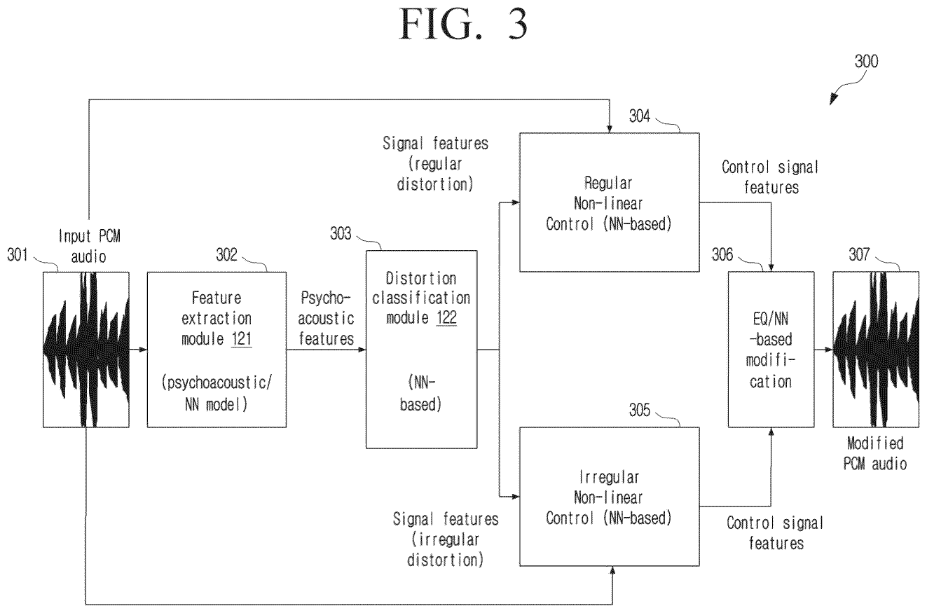

In one or more embodiments, the feature extraction module 121 is configured to extract a plurality of audio feature signatures (e.g., psychoacoustic features) from a plurality of audio signals, where the plurality of audio feature signatures are extracted prior to a playback of the plurality of audio signals, as illustrated in conjunction with FIG. 3 through FIG. 7. The extraction process may involve identifying and capturing key characteristics of the plurality of audio signals, which can include properties such as frequency, amplitude, and phase. By extracting the plurality of audio feature signatures in advance, the system 101 may analyze and process the audio data to enhance the playback experience or perform other functions based on the extracted features.

For example, in a smart speaker system associated with the electronic device 100, the feature extraction module 121 may extract audio feature signatures such as voice patterns, ambient noise levels, and speech characteristics from incoming voice commands before playing back the audio response. Similarly, in a music streaming application of the electronic device 100, the feature extraction module 121 may extract audio feature signatures such as rhythm patterns, pitch characteristics, and instrument timbres from music tracks before they are played back to the user.

In one or more embodiments, the feature extraction module 121 may execute multiple operations to extract the plurality of audio feature signatures from the plurality of audio signals.

The feature extraction module 121 is configured to identify one or more characteristics of each audio signal associated with the plurality of audio signals. The one or more characteristics of the audio signal may include, but are not limited to, at least one of a stationary signal, a quasi-stationary signal, and a transient signal. The feature extraction module 121 is configured to segment, based on the one or more identified characteristics, the plurality of audio signals. The feature extraction module 121 is configured to extract, using at least one of a transformation mechanism, a type of transformation, a filter-bank mechanism, and a neural network (NN) based dimensionality reduction mechanism, the plurality of audio feature signatures from each segment. The plurality of audio feature signatures may include, but are not limited to, at least one of a power spectrum density, a root mean square (RMS) value, or a peak value of the signal.

For example, in a voice recognition system associated with the electronic device 100, the feature extraction module 121 may analyze incoming speech signals to identify stationary segments (e.g., vowels), quasi-stationary segments (e.g., formants), and transient segments (e.g., plosive sounds). The feature extraction module 121 then uses transformation mechanisms to extract audio feature signatures such as spectral centroid, zero-crossing rate, and Mel-frequency cepstral coefficients (MFCCs) from each segment for further analysis and processing.

In one or more embodiments, the distortion classification module 122 is configured to identify one or more regular microspeaker distortions and one or more irregular microspeaker distortions from the plurality of extracted audio feature signatures, as illustrated in conjunction with FIG. 3 through FIG. 7.

In one or more embodiments, the distortion classification module 122 may execute multiple operations to identify the one or more regular microspeaker distortions and the one or more irregular microspeaker distortions from the plurality of extracted audio feature signatures, where said operations are explained below.

The distortion classification module 122 is configured to compare the extracted plurality of audio feature signatures from a current segment with the extracted plurality of audio feature signatures from a previous segment that is free from the one or more regular microspeaker distortions and the one or more irregular microspeaker distortions. This comparison aims to identify and distinguish regular and irregular microspeaker distortions present in the extracted audio feature signatures. Subsequently, the distortion classification module 122 is further configured to determine whether the current audio segment generates the audible distortions based on a result of the comparison. The distortion classification module 122 is trained based on at least one of measured excursion and measured acoustic data to determine the one or more regular microspeaker distortions and the one or more irregular microspeaker distortions for the plurality of audio signals with different measurement parameters or conditions.

For example, in a sound reinforcement system associated with the electronic device 100, the distortion classification module 122 may compare the audio feature signatures extracted from the current segment with those from a reference segment (free from distortions) to identify regular and irregular microspeaker distortions. The distortion classification module 122 may then determine whether the current audio segment exhibits audible distortions based on the comparison results. Additionally, the distortion classification module 122 may be trained using measured excursion and acoustic data obtained under different measurement conditions to accurately classify regular and irregular distortions in audio signals.

For example, in an audio playback system associated with the electronic device 100, the distortion classification module 122 may compare the audio feature signatures of a current segment with those of a reference segment known to be distortion-free. By analyzing differences in the feature signatures, the distortion classification module 122 may identify regular distortions (such as harmonic distortion) and irregular distortions (such as clipping or rubbing noise) present in the current audio segment. This allows the system 101 to take corrective measures or apply appropriate processing to mitigate the impact of these distortions on the audio playback quality.

The distortion classification module 122 is further configured to determine one or more parameters associated with the electronic device. The one or more parameters may include, but are not limited to, application characteristic information, target audio application information, audio content information, processing capability information, and available computational resource information. The distortion classification module 122 is further configured to select, based on the one or more determined parameters, a neural network (NN) based mechanism or digital signal processing (DSP) based mechanism for the distortion classification module to determine the one or more regular microspeaker distortions and the one or more irregular microspeaker distortions from the plurality of extracted audio feature signatures.

For example, in a smartphone audio processing system associated with the electronic device 100, the distortion classification module 122 may consider parameters such as the type of audio application being used (e.g., music playback, voice calls, low latency application, high latency application, etc.), the processing capability of the electronic device 100, and the available computational resources at the electronic device 100 to determine the one or more regular microspeaker distortions and the one or more irregular microspeaker distortions. Based on these parameters, the distortion classification module 122 may choose to employ the neural network (NN) mechanism for distortion classification when the electronic device 100 has sufficient computational resources and processing capability. Conversely, if the resources of electronic device 100 are limited, the distortion classification module 122 may opt for the DSP mechanism for the distortion classification to efficiently handle the classification task.

In one or more embodiments, the distortion classification module 122 is further configured to extract one or more signal segments that cause the one or more regular microspeaker distortions and the one or more irregular microspeaker distortions. The distortion classification module 122 is further configured to extract the plurality of audio feature signatures that cause the one or more regular microspeaker distortions and the one or more irregular microspeaker distortions.

In one or more embodiments, the correction module 123 is configured to filter the one or more determined regular and irregular microspeaker distortions that cause one or more damageable or audibly distorted audio movements associated with one or more membranes of a speaker 140 of the electronic device 100. The correction module 123 is further configured to generate one or more corrected audio signals for the playback by filtering the one or more determined regular and irregular microspeaker distortions from the plurality of extracted audio feature signatures, as illustrated in conjunction with FIG. 3 to FIG. 7.

In one or more embodiments, the correction module 123 may execute multiple operations to generate the one or more corrected audio signals, which are described below.

The correction module 123 is configured to perform, based on the one or more determined regular microspeaker distortions and the one or more determined irregular microspeaker distortions, waveform correction by utilizing at least one of an equalization filter (EQ) based modification mechanism, a neural network (NN) based modification, and a stochastic based processing mechanism. The correction module 123 is further configured to generate, based on the performed waveform correction, the one or more corrected audio signals for the playback.

For example, consider a scenario where the user of the electronic device 100 records their voice, the electronic device 100 detects regular microspeaker distortions (e.g., background noise, frequency imbalances) and irregular microspeaker distortions (e.g., pops, crackles, sudden volume changes). The correction module 123 then applies waveform correction using EQ-based modification, NN-based modification, and/or stochastic-based processing to eliminate these distortions. The result is a corrected audio signal that is ready for playback or further processing.

For example, consider a scenario where the correction module 123 may be integrated into a voice-over-IP (VOIP) platform or a conferencing system. When users engage in voice calls or conferences, the electronic device 100 analyzes the audio signals for regular and irregular distortions caused by network transmission, microphone quality, or environmental factors. The correction module 123 then utilizes EQ-based modification, NN-based modification, and/or stochastic-based processing to correct the waveform distortions in real-time, ensuring that the audio signals received by participants are clear and free from unwanted artifacts.

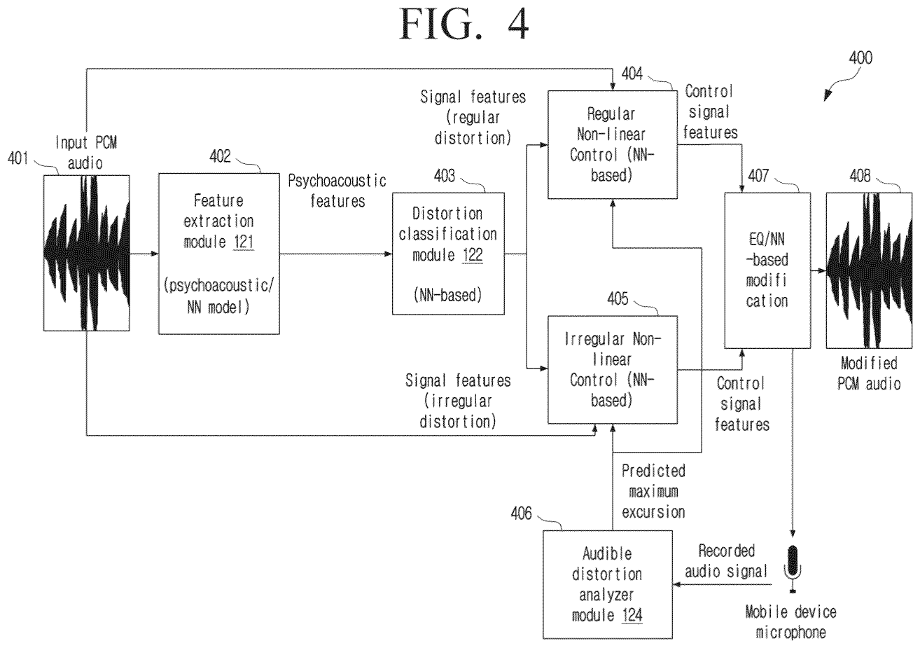

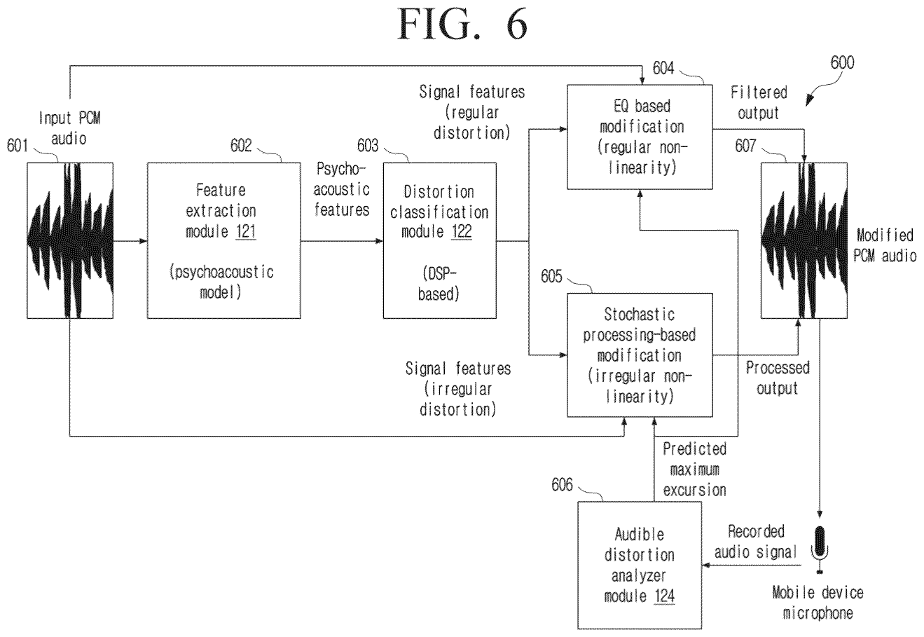

In one or more embodiments, the audible distortion analyzer module 124 is configured to determine a maximum speaker displacement value associated with the plurality of audio signals using a regression model to improve the accuracy of at least one of the EQ-based modification mechanism, the neural network (NN) based modification and the stochastic based processing mechanism, as illustrated in conjunction with FIG. 4 and FIG. 6. Here, the term “maximum speaker displacement value” refers to the maximum distance traveled by the diaphragm (cone membrane) of the speaker 140 when driven by the audio signals. The regression model is used to analyze the relationship between the audio signals and the corresponding speaker displacement values to identify patterns and trends in speaker displacement across different audio signals. The purpose of this analysis is to improve the accuracy of the EQ-based modification mechanism, the neural network (NN) based modification, and the stochastic-based processing mechanism. By understanding the relationship between speaker displacement and audio signals, these mechanisms can be fine-tuned to account for variations in speaker behavior and optimize the correction of audio distortions caused by these variations.

In one or more embodiments, for selecting the feature extraction module 121 (e.g. psychoacoustic models such as mp3 psychoacoustic model, models to compute psychoacoustic indicators such as loudness and sharpness etc.) to extract the plurality of audio feature signatures from the plurality of audio signals, the electronic device 100 may execute multiple operations, which are described below.

The electronic device 100 is configured to determine one or more characteristics of each input audio signal associated with the plurality of audio signals, wherein the one or more characteristics of the audio signal comprises at least one of a stationary signal, a quasi-stationary signal, and a transient signal. The electronic device 100 is further configured to segment, based on the determined one or more determined characteristics, the plurality of audio signals. The electronic device 100 is further configured to extract, using at least one of a transformation mechanism, a filter-bank mechanism, and a neural network (NN) based dimensionality reduction mechanism, the plurality of audio feature signatures from each segment, wherein the plurality of audio feature signatures comprises at least one of the power spectrum density, the RMS value, and the peak value. The electronic device 100 is further configured to compare the extracted plurality of audio features from a current segment with the extracted plurality of audio features from a previous segment (i.e., a plurality of reference audio features) and previously trained data that is free from audible distortions to determine at least one of one or more probability scores and one or more confidence intervals. The electronic device 100 is further configured to validate at least one of the one or more determined probability scores and one or more determined confidence intervals using manually labeled data for evaluating performance with the distortion classification module. The electronic device 100 is further configured to select, based on a result of validation, the feature extraction module 121.

The communicator 130 is configured for communicating internally between internal hardware components and with external devices (e.g., server) via one or more networks (e.g., radio technology). The communicator 130 includes an electronic circuit specific to a standard that enables wired or wireless communication.

In one or more embodiments, a function associated with the various components of the electronic device 100 may be performed through the non-volatile memory, the volatile memory, and the processor 120. One or a plurality of processors controls the processing of the input data in accordance with a predefined operating rule or Artificial intelligence (AI) model stored in the non-volatile memory and the volatile memory. The predefined operating rule or AI model is provided through training or learning. Here, being provided through learning means that, by applying a learning algorithm to a plurality of learning data (e.g., the plurality of audio feature signatures, one or more characteristics of the audio signal, one or more parameters, etc.), a predefined operating rule or AI model of the desired characteristic is made. The learning may be performed in a device itself in which AI according to an embodiment is performed, and/or may be implemented through a separate server/system. The learning algorithm is a method for training a predetermined target device (for example, a robot) using a plurality of learning data to cause, allow, or control the target device to decide or predict. Examples of learning algorithms include, but are not limited to, supervised learning, unsupervised learning, semi-supervised learning, or reinforcement learning.

The AI model may consist of a plurality of neural network layers. Each layer has a plurality of weight values and performs a layer operation through a calculation of a previous layer and an operation of a plurality of weights. Examples of neural networks include, but are not limited to, convolutional neural network (CNN), deep neural network (DNN), recurrent neural network (RNN), Long Short-Term Memory (LSTM), Gated Recurrent Unit (GRU), bidirectional recurrent deep neural network (BRDNN), and deep Q-networks.

In one or more embodiments, an AI-based method for managing speaker damage in an electronic device is described. The method includes playing a plurality of audio signals having the plurality of audio feature signatures; measuring during playing, movement of one or more membranes of the speaker 140 of the electronic device 100; generating an AI model having a correlation between the plurality of audio feature signatures and the measured movement of the one or more membranes; and referring to the generated AI model during subsequent playing, to remove the audio feature signatures that cause movement of membranes beyond a pre-defined threshold associated with one or more irregular distortions.

The speaker 140 (micro speaker) is a compact electroacoustic transducer that converts electrical signals into sound waves. The speaker 140 typically consists of a small diaphragm and voice coil that produce audio output. The micro microphone 150 is a miniature transducer that converts sound waves into electrical signals. The micro microphone 150 contains a small diaphragm that responds to sound pressure variations, generating an electrical signal.

Although FIG. 2 shows various hardware components of the electronic device 100, but it is to be understood that other embodiments are not limited thereon. In other embodiments, the electronic device 100 may include less or more number of components. Further, the labels or names of the components are used only for illustrative purposes and do not limit the scope of the disclosure. One or more components can be combined to perform the same or substantially similar functions to manage the speaker damage in the electronic device 100.

FIG. 3 illustrates a scenario 300 where the electronic device 100 utilizes a neural network (NN) based mechanism to generate the one or more corrected audio signals for the playback (the plurality of audio signals), according to an embodiment.

At operations 301-302, the feature extraction module 121 receives the plurality of audio signals (e.g., input pulse-code modulation (PCM) audio). Upon receiving the plurality of audio signals, the feature extraction module 121 extracts the plurality of audio feature signatures (e.g., psychoacoustic signal features) from the plurality of audio signals by utilizing at least one of a psychoacoustic model and an NN model. In one or more embodiments, the feature extraction module 121 utilizes a combination of the psychoacoustic model and the NN-model for speaker excursion control using only audio signals as input without any additional hardware sensing. In one or more embodiments, the psychoacoustic model and the NN-model may be customized to extract the perceptually relevant feature sets that cause speaker excursion and sound distortion.

At operation 303, the distortion classification module 122 separates the plurality of audio feature signatures that contribute to both regular microspeaker distortions (regular non-linearity/regular distortions) and irregular microspeaker distortions (irregular non-linearity/irregular distortions). This is achieved through a training mechanism. The regular microspeaker distortions are characterized by consistent mild non-linearities, such as those found in music signals like drums, bass, and male speech, particularly with higher energy in low frequencies below 1-2 kHz. On the other hand, the irregular microspeaker distortions are associated with audio feature signatures that cause severe audible irregular distortions, such as sharp attack times in music signals from instruments like piano and guitar.

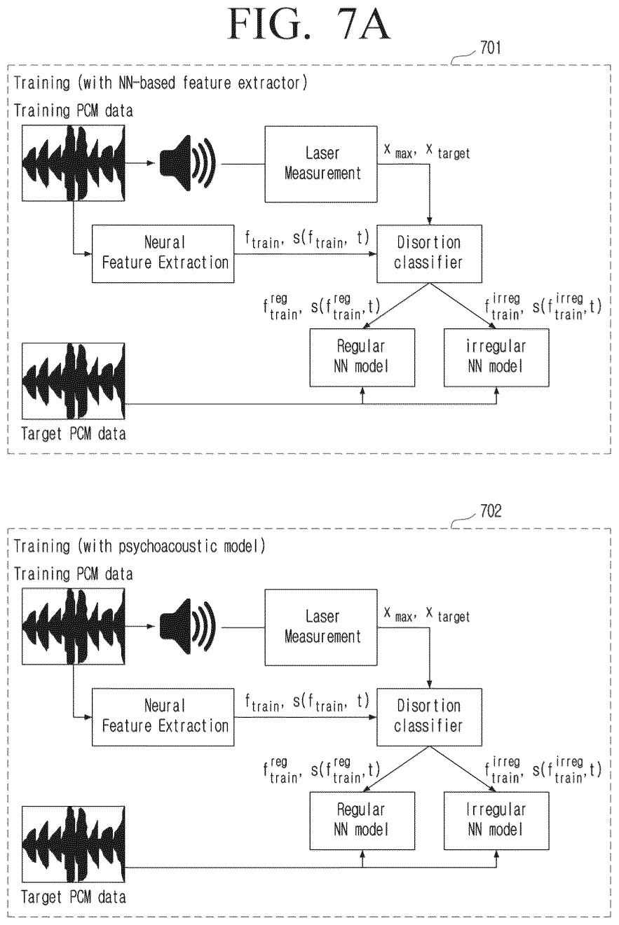

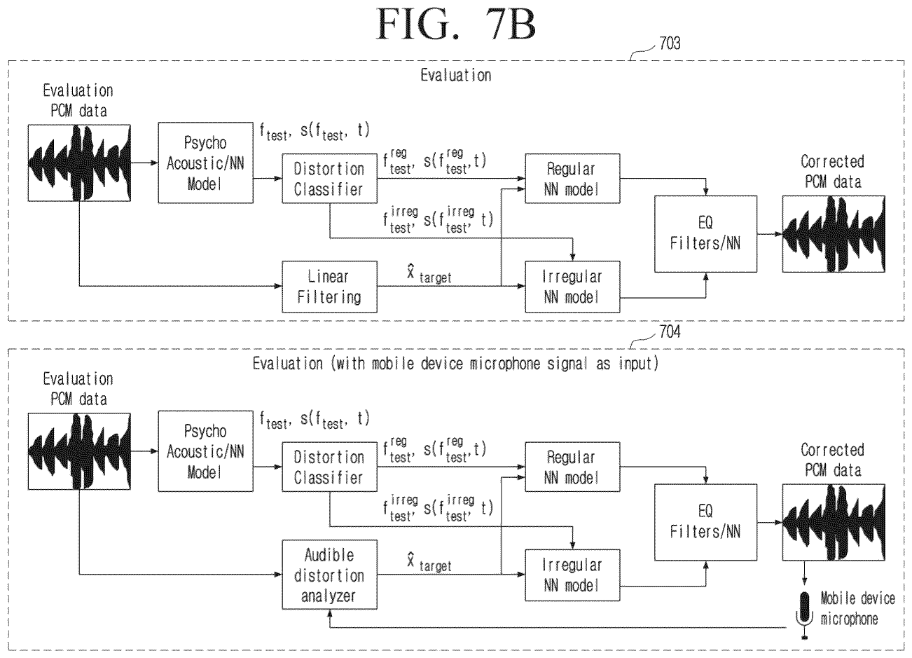

The distortion classification module 122 may be developed and trained using measured excursion and/or acoustic data to identify regular and irregular non-linear signal features, including spectral, temporal, and phase features, for different PCM audio signals, as described in conjunction with FIG. 7. This allows electronic device 100 to be more robust across various measurement parameters and conditions, such as different kinds of music, speech, movie/gaming sounds, micro-speaker types, and input voltage/current levels. The data for these measurements can be obtained using laser-based methods for speaker excursion measurement and acoustic measurements for sound pressure.

The distortion classification module 122 may be implemented using neural network-based approaches, such as convolutional neural networks (CNNs), recurrent neural network (RNN), or digital signal processing (DSP)-based methods. The DSP-based methods may involve identifying spectral harmonics or peak-RMS values in the spectrum, as well as using peak detectors for phase-based features, among other techniques.

At operations 304-305, after the classification operation, the correction module 123 generates a plurality of control signal features that filter the determined regular and irregular microspeaker distortions. These distortions are responsible for causing audible distortions and potential damage to the audio movements associated with the speaker 140 of the electronic device 100. The correction module 123 achieves this by utilizing a regular non-linear control neural network (NN) module and an irregular non-linear control neural network (NN) module. The regular non-linear control neural network (NN) module is trained to generate one or more first control signal features of the plurality of control signal features based on the output of the distortion classification module and target audio data without regular microspeaker distortions (e.g., input PCM audio). Similarly, the irregular non-linear control neural network (NN) module is trained to generate one or more second control signal features of the plurality of control signal features based on the output of the distortion classification module and the target audio data without irregular microspeaker distortions (e.g., input PCM audio). These control signal features are designed to mitigate the impact of both regular and irregular distortions on the speaker's membranes, ultimately improving the audio quality and protecting the speaker from potential damage.

At operations 306-307, after the filtering operation, the correction module 123 generates the one or more corrected audio signals (waveform correction/modified PCM audio) for the playback by utilizing the equalization filter (EQ) based modification mechanism and/or the neural network (NN) based modification mechanism.

The EQ-based waveform correction involves the use of filters with adjustable parameters that may include, but are not limited to, gain and Q-factor to perform waveform correction. The filter configurations and design can be predetermined based on an analysis of the measured speaker behavior and the desired level of accuracy. The adjustable parameters, such as gain and Q-factor, can be chosen based on a look-up table and corresponding values of input parameters, such as the plurality of control signal features. Examples of EQ-based correction may include, but are not limited to, graphic equalization filters and parametric equalization filters. The EQ can be designed using frequency characteristics similar to auditory model-based filter banks, such as Equivalent Rectangular Bandwidth (ERB)-based, gammatone filter banks. On the other hand, NN-based waveform correction involves neural feature extraction to derive an end-to-end neural network (NN) model by modifying the input PCM audio/waveform based on the plurality of control signal features computed using the NN-based models. This approach utilizes neural networks to extract features from the input PCM audio/waveform and apply corrections to achieve the desired audio output based on the control signal features generated by the NN-based models.

For example, consider a scenario where a team of audio engineers is working on developing a high-fidelity audio system for smart speakers. The smart speakers are designed to deliver exceptional sound quality across a wide range of audio content, including music, movies, and gaming audio. In this scenario, the engineers are focusing on implementing advanced waveform correction techniques to ensure that the speakers produce accurate and distortion-free audio output. The engineers decide to use a combination of EQ-based and NN-based waveform correction methods to achieve the desired results. For the EQ-based waveform correction, the team of audio engineers conducts detailed measurements of the behavior of the speaker 140 and analyzes the frequency response characteristics. Based on this analysis, they design graphic equalization filters and parametric equalization filters with tunable parameters such as gain and Q-factor. These filters are configured to correct specific frequency ranges and address irregularities in the output of the speaker 140. In parallel, the team of audio engineers develops NN-based waveform correction models that utilize neural feature extraction to derive an end-to-end NN model. This model modifies the input PCM waveform based on control signal features computed using the NN-based models. The neural networks are trained to extract relevant features from the input PCM waveform and apply corrections to ensure accurate and high-fidelity audio output. By combining these EQ-based and NN-based waveform correction techniques, the team of audio engineers aims to create a sophisticated audio processing system that can adapt to different types of audio content and deliver exceptional sound quality while protecting the speaker 140 from potential damage caused by irregular distortions.

FIG. 4 illustrates a scenario 400 where the electronic device 100 utilizes the NN-based mechanism and real-time prediction of maximum excursion to generate the one or more corrected audio signals for the playback, according to an embodiment.

At operations 401-402, the feature extraction module 121 receives the plurality of audio signals (e.g., input pulse-code modulation (PCM) audio), which may relate to operations 301-302. Upon receiving the plurality of audio signals, the feature extraction module 121 extracts the plurality of audio feature signatures (e.g., psychoacoustic signal features) from the plurality of audio signals by utilizing at least one of the psychoacoustic model and the NN model. In one or more embodiments, the feature extraction module 121 utilizes the combination of the psychoacoustic model and the NN-model for speaker excursion control using only audio signals as input without any additional hardware sensing. In one or more embodiments, the psychoacoustic model and the NN-model may be customized to extract the perceptually relevant feature sets that cause speaker excursion and sound distortion.

At operation 403, the distortion classification module 122 separates the plurality of audio feature signatures (signal features) that contribute to both regular microspeaker distortions (regular non-linearity/regular distortions) and irregular microspeaker distortions (irregular non-linearity/irregular distortions), which may relate to operation 303. This is achieved through the training mechanism. The regular microspeaker distortions are characterized by consistent mild non-linearities, such as those found in music signals like drums, bass, and male speech, particularly with higher energy in low frequencies below 1-2 kHz. On the other hand, the irregular microspeaker distortions are associated with audio feature signatures that cause severe audible irregular distortion, such as sharp attack times in music signals from instruments like piano and guitar. The distortion classification module 122 may be developed and trained using measured excursion and/or acoustic data to identify regular and irregular non-linear signal features, including spectral, temporal, and phase features, for different PCM audio signals, as described in conjunction with FIG. 7. This allows the electronic device 100 to be more robust across various measurement parameters and conditions, such as different kinds of music, speech, movie/gaming sounds, micro-speaker types, and input voltage/current levels. The data for these measurements can be obtained using laser-based methods for speaker excursion measurement and acoustic measurements for sound pressure.

The distortion classification module 122 may be implemented using neural network-based approaches, such the CNNs, RNNs, or the DSP-based methods. The DSP-based methods may involve identifying spectral harmonics or peak-RMS values in the spectrum, as well as using peak detectors for phase-based features, among other techniques.

At operations 404, 405, and 406, after the classification operation, the correction module 123 generates the plurality of control signal features that filter the determined regular and irregular microspeaker distortions by utilizing the audible distortion analyzer module 124. These distortions are responsible for causing audible distortions and potential damage to the audio movements associated with the speaker 140 of the electronic device 100. The correction module 123 achieves this by utilizing the regular non-linear control neural network (NN) module and the irregular non-linear control neural network (NN) module.

The regular non-linear control neural network (NN) module is trained to generate the one or more first control signal features of the plurality of control signal features based on the output of the distortion classification module, target audio data without regular microspeaker distortions (e.g., input PCM audio), and an output of the audible distortion analyzer module 124. Similarly, the irregular non-linear control neural network (NN) module is trained to generate the one or more second control signal features of the plurality of control signal features based on the output of the distortion classification module, the target audio data without irregular microspeaker distortions (e.g., input PCM audio), and the output of the audible distortion analyzer module 124. These control signal features are designed to mitigate the impact of both regular and irregular distortions on the speaker's membranes, ultimately improving the audio quality and protecting the speaker from potential damage.

The audible distortion analyzer module 124 receives a recorded audio signal from the microphone 150, the microphone 150 receives an output signal from the equalization filter (EQ) based modification mechanism and/or the neural network (NN) based modification mechanism. In other words, an alternative approach, compared to FIG. 3, entails leveraging the electronic device 100 (e.g., mobile device microphone) to capture the audio signal emanating from the speakers and perform real-time prediction of the maximum excursion. This predicted maximum excursion value serves as an input to the NN-based model (404 and 405), thereby contributing to the refinement and enhancement of the accuracy of the non-linear control mechanism. This approach aims to utilize real-time data from the audio playback to optimize the performance of the NN-based model (404 and 405) and improve its ability to effectively manage non-linear distortions in the audio output.

At operations 407-408, after the filtering operation, the correction module 123 generates the one or more corrected audio signals (waveform correction/modified PCM audio) for the playback by utilizing the equalization filter (EQ) based modification mechanism and/or the neural network (NN) based modification mechanism. The EQ-based waveform correction involves the use of filters with adjustable parameters that may include, but are not limited to, gain and Q-factor to perform waveform correction. The filter configurations and design can be predetermined based on an analysis of the measured speaker behavior and the desired level of accuracy. The adjustable parameters, such as gain and Q-factor, can be chosen based on a look-up table and corresponding values of input parameters, such as the plurality of control signal features. Examples of EQ-based correction may include, but are not limited to, graphic equalization filters and parametric equalization filters. The EQ can be designed using frequency characteristics similar to auditory model-based filter banks, such as ERB-based filter banks. On the other hand, NN-based waveform correction involves neural feature extraction to derive an end-to-end neural network (NN) model by modifying the input PCM audio/waveform based on the plurality of control signal features computed using the NN-based models. This approach utilizes neural networks to extract features from the input PCM audio/waveform and apply corrections to achieve the desired audio output based on the control signal features generated by the NN-based models.

In one or more embodiments, for audio signal analysis, the use of the audible distortion analyzer module 124 involves an application of objective metrics, such as a perception model-based quality (PEMO-Q), in combination with measured displacement values and acoustic data obtained from the speaker 140 (with and without audio signal distortion). This audio signal analysis aims to estimate a target displacement (Xtarget), refer FIG. 7, by utilizing the regression model, particularly a generalized linear regression model. The selection of the signal model is based on the distribution of the input PCM audio signal and the captured displacement data.

For example, consider a scenario associated with an audio testing laboratory, the audible distortion analyzer module 124 is used to evaluate the performance of a new speaker prototype. The audible distortion analyzer module 124 utilizes PEMO-Q metrics, along with measured displacement values and acoustic data, to estimate the target displacement of the speaker 140 under different audio signal conditions. The generalized linear regression model is employed to analyze the relationship between the audio signal distortion and the displacement of the speaker 140, providing valuable insights for optimizing the performance of the speaker 140.

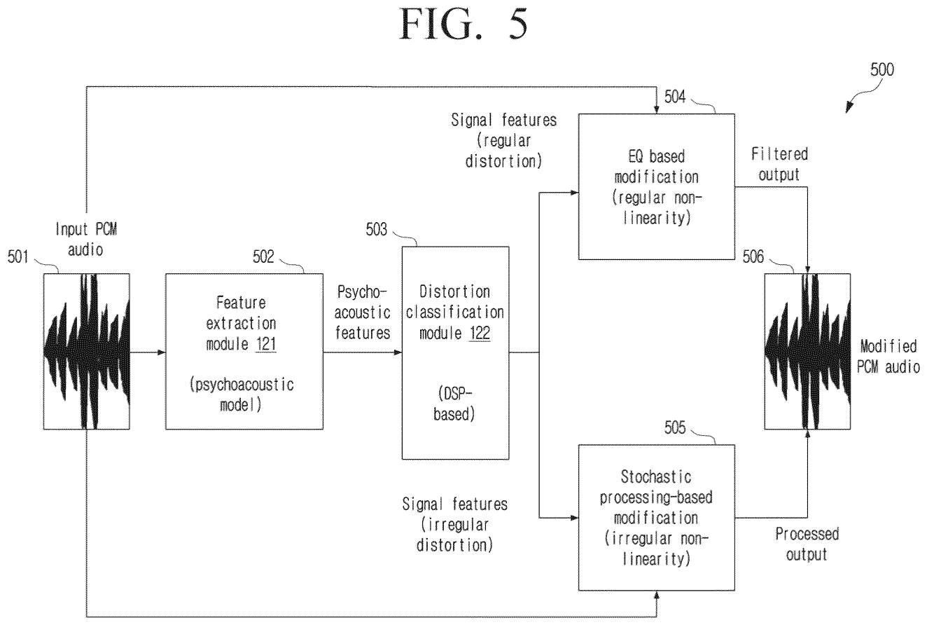

FIG. 5 illustrates a scenario 500 where the electronic device 100 utilizes the DSP based mechanism to generate the one or more corrected audio signals for the playback, according to an embodiment.

At operations 501-502, the feature extraction module 121 receives the plurality of audio signals (e.g., input PCM audio). Upon receiving the plurality of audio signals, the feature extraction module 121 extracts the plurality of audio feature signatures (e.g., psychoacoustic signal features) from the plurality of audio signals by utilizing the psychoacoustic model. In one or more embodiments, the feature extraction module 121 utilizes the psychoacoustic model for speaker excursion control using only audio signals as input without any additional hardware sensing. In one or more embodiments, the psychoacoustic model may be customized to extract the perceptually relevant feature sets that cause speaker excursion and sound distortion.

At operation 503, the distortion classification module 122 separates the plurality of audio feature signatures that contribute to two distinct categories of microspeaker distortions: regular microspeaker distortions (regular non-linearity/regular distortions) and irregular microspeaker distortions (irregular non-linearity/irregular distortions). This separation is achieved through a specialized training mechanism, as described in conjunction with FIG. 7. The regular microspeaker distortions are characterized by consistent mild non-linearities, commonly found in music signals such as drums, bass, and male speech, particularly with higher energy in low frequencies below 1-2 kHz. On the other hand, the irregular microspeaker distortions are associated with audio feature signatures that cause severe audible irregular distortion, such as sharp attack times in music signals from instruments like piano and guitar. The distortion classification module 122 is developed and trained using measured excursion and/or acoustic data to identify regular and irregular non-linear signal features, including spectral, temporal, and phase features, for different PCM audio signals, as described in conjunction with FIG. 7. This enables the distortion classification module 122 to exhibit robustness across various measurement parameters and conditions, encompassing different types of music, speech, movie/gaming sounds, micro-speaker types, and input voltage/current levels. The required data for these measurements can be obtained using laser-based methods for speaker excursion measurement and acoustic measurements for sound pressure.

The distortion classification module 122 may be implemented using the DSP-based methods. The DSP-based methods may involve identifying spectral harmonics or peak-RMS values in the spectrum, as well as using peak detectors for phase-based features, among other techniques. In other words, for scenarios that demand low-latency processing, such as gaming applications, the use of neural network (NN)-based processing may not be suitable for non-linear control. Instead, for low-latency processing, the utilization of DSP-based methods is recommended. The DSP-based methods may include the implementation of equalization filters and stochastic processing, which may relate to operation 504-505, which have the capability to reduce complexity and computation time. For example, in the context of real-time game audio processing, where minimal latency is crucial for an immersive gaming experience, the adoption of DSP-based equalization filters and stochastic processing techniques can effectively address non-linear control requirements while meeting the stringent low-latency demands of the gaming environment.

At operations 504, 505, and 506, after the classification operation, the correction module 123 generates one or more filtered outputs and/or one or more processed outputs, which may relate to the plurality of control signal features, that filter the determined regular and irregular microspeaker distortions. The correction module 123 utilizes the one or more generated filtered outputs and/or one or more generated processed outputs to generate the one or more corrected audio signals (waveform correction/modified PCM audio) for the playback. The correction module 123 achieves this by utilizing the equalization filter (EQ) based modification mechanism for regular non-linearity and the stochastic based processing mechanism for irregular non-linearity.

The EQ-based based modification mechanism involves the use of filters with adjustable parameters that may include, but are not limited to, gain and Q-factor to perform waveform correction. The filter configurations and design can be predetermined based on an analysis of the measured speaker behavior and the desired level of accuracy. The adjustable parameters, such as gain and Q-factor, can be chosen based on a look-up table and corresponding values of input parameters, such as the plurality of control signal features. Examples of EQ-based correction may include, but are not limited to, graphic equalization filters and parametric equalization filters. The EQ can be designed using frequency characteristics similar to auditory model-based filter banks, such as ERB-based filter banks.

On the other hand, the stochastic-based processing mechanism involves an application of signal processing techniques to model irregular non-linearities and modify waveforms. For instance, models such as Gaussian Mixture Models, Poisson, Markov Chains, or Bernoulli's process can be employed to achieve this. For example, consider an application of stochastic-based processing mechanism in the field of audio signal processing. By utilizing the Gaussian Mixture Models to represent and modify irregular non-linearities in audio waveforms, it becomes possible to introduce controlled randomness and variability to the signal, leading to unique and expressive audio effects. Similarly, the use of Markov Chains for waveform modification can result in dynamic and unpredictable transformations of audio signals, adding richness and complexity to the sound output. These stochastic-based processing mechanisms play a crucial role in enabling innovative audio processing applications that require the introduction of controlled randomness and irregularities.

FIG. 6 illustrates a scenario 600 where the electronic device 100 utilizes the DSP-based mechanism and real-time prediction of maximum excursion to generate the one or more corrected audio signals for the playback, according to an embodiment.

At operations 601-602, the feature extraction module 121 receives the plurality of audio signals (e.g., input PCM audio), which may relate to operations 501-502. Upon receiving the plurality of audio signals, the feature extraction module 121 extracts the plurality of audio feature signatures (e.g., psychoacoustic signal features) from the plurality of audio signals by utilizing the psychoacoustic model. In one or more embodiments, the feature extraction module 121 utilizes the psychoacoustic model for speaker excursion control using only audio signals as input without any additional hardware sensing. In one or more embodiments, the psychoacoustic model may be customized to extract the perceptually relevant feature sets that cause speaker excursion and sound distortion.

At operation 603, the distortion classification module 122 separates the plurality of audio feature signatures that contribute to two distinct categories of microspeaker distortions: regular microspeaker distortions (regular non-linearity/regular distortions) and irregular microspeaker distortions (irregular non-linearity/irregular distortions), which may relate to operations 503. This separation is achieved through the specialized training mechanism, as described in conjunction with FIG. 7. The distortion classification module 122 may be implemented using the DSP-based methods. The DSP-based methods may involve identifying spectral harmonics or peak-RMS values in the spectrum, as well as using peak detectors for phase-based features, among other techniques. In other words, for scenarios that demand low-latency processing, such as gaming applications, the use of neural network (NN)-based processing may not be suitable for non-linear control. Instead, for low-latency processing, the utilization of DSP-based methods is recommended. The DSP-based methods may include the implementation of equalization filters and stochastic processing, which may relate to operation 604-605, which have the capability to reduce complexity and computation time.

In one or more embodiments, the distortion classification module 122 is developed and trained using measured excursion and/or acoustic data to identify regular and irregular non-linear signal features, including spectral, temporal, and phase features, for different PCM audio signals, as described in conjunction with FIG. 7. This enables the distortion classification module 122 to exhibit robustness across various measurement parameters and conditions, encompassing different types of music, speech, movie/gaming sounds, micro-speaker types, and input voltage/current levels. The required data for these measurements can be obtained using laser-based methods for speaker excursion measurement and acoustic measurements for sound pressure.

At operations 604, 605, 606 and 607, after the classification operation, the correction module 123 generates one or more filtered outputs and/or one or more processed outputs, which may relate to the plurality of control signal features, that filter the determined regular and irregular microspeaker distortions. The correction module 123 utilizes the one or more generated filtered outputs and/or one or more generated processed outputs and the audible distortion analyzer module 124 to generate the one or more corrected audio signals (waveform correction/modified PCM audio) for the playback. The correction module 123 achieves this by utilizing the equalization filter (EQ) based modification mechanism for regular non-linearity and the stochastic based processing mechanism for irregular non-linearity. Further, a detailed description related to the EQ-based based modification mechanism/stochastic-based processing mechanism/audible distortion analyzer module 124 is already covered in the description related to FIG. 5 and is omitted herein for the sake of brevity.

FIG. 7A, 7B illustrate one or more example scenarios 701, 702, 703, and 704 involving the training and evolution of the NN models to generate the one or more corrected audio signals for the playback, according to an embodiment. For the training purposes, one or more training inputs, one or more inference inputs, and one or more inference are utilized by the NN model, for example, as described in Table-1 below. In the field of NNs, there are several types of architectures and models that are commonly used for various tasks. Here are some examples of neural network architectures, a shallow fully connected neural network, a time-delayed neural network (TDNN), a temporal convolutional network (TCN), the RNN, the LSTM, etc.

TABLE 1

| | |
|---|---|
| Training | Laser measurements: Target speaker excursion level X_{target}, |
| inputs | Maximum speaker excursion level Xₘₐₓ |
| | Psychoacoustic signal features fₜᵣₐᵢₙ, S(fₜᵣₐᵢₙ, t) |
| | $Regular non - linear NN models input - {f}_{train}^{reg} , S ( {f}_{train}^{reg} , t )$ |
| | $Irregular non - linear NN models input - {f}_{train}^{irreg} , S ( {f}_{train}^{irreg} , t )$ |
| | Training and target PCM signal |
| Inference | Input signal features fₜₑₛₜ, S(fₜₑₛₜ, t) |
| inputs | Estimated target displacement level X_{target} using linear |
| | filtering/device microphone signal |
| Inference | Corrected PCM signal (after modification to minimize |
| output | distortion), |

Furthermore, the distortion classification module 122 is trained using psychoacoustic/NN features extracted from the signal under test and target signals. The distortion classification module 122 works in two ways: it extracts signal segments (PCM samples) causing regular and irregular non-linear behavior or extracts signal features (frequency points/bins, signal statistics such as signal power, envelope, peak RMS, etc.) for signals causing regular and irregular non-linear behavior. Additionally, the regular NN model is trained based on the output of the distortion classification module 122 (signal segments or signal features causing regular non-linear speaker behavior) and target PCM audio data without any audible distortions. Similarly, the irregular NN model is trained based on the output of the distortion classification module 122 and target PCM audio data without any audible distortions.

The testing dataset, distinct from the training and target data used in the training pipeline, is employed for evaluation purposes. The psychoacoustic features are extracted from the test data and subsequently utilized by the distortion classification module 122 to differentiate between signal samples or features that cause regular and irregular non-linear distortion. In order to mitigate audible distortions, EQ filters or neural network-based control methods are implemented.

In one or more embodiments, for selecting the feature extraction module 121 (psychoacoustic/NN model) to extract the plurality of audio feature signatures from the plurality of audio signals, the electronic device 100 may execute multiple operations, for example, which are given below:

Segmenting training samples to identify audible signal distortion using signal transforms. This may include, but not limited to, using constant block length for stationary signals and employing long and short block switching with FFT-based computation for transient signals.

Signal segments are represented in another domain, filter bank, or NN-based dimensionality reduction using a combination of methods. These methods include transforms such as FFT-based power spectrum computation, filter banks like gammatone and modulation, and dimensionality reduction techniques such as PCA and autoencoders. The goal is to analyze signal features such as power spectrum density, root mean square (RMS) value, peak value, etc.

Different signal features are tested to fine-tune the distortion classification module 122 for identifying audible distortion in the current signal segment.

The extracted features of the current segment are compared to the same signal features computed for previous frames that are known not to cause audible distortions. This comparison is used to compute probability scores and confidence intervals.

Probability scores and confidence intervals are validated using manually labelled testing data to evaluate the performance of the distortion classification module 122.

If the accuracy of the distortion classification module 122 with the selected features for correctly identifying audible distortion frames is less than a threshold, for example 99%, an offline iterative procedure is initiated. This involves iterating through operations a-e to improve the accuracy of the distortion classification module 122.

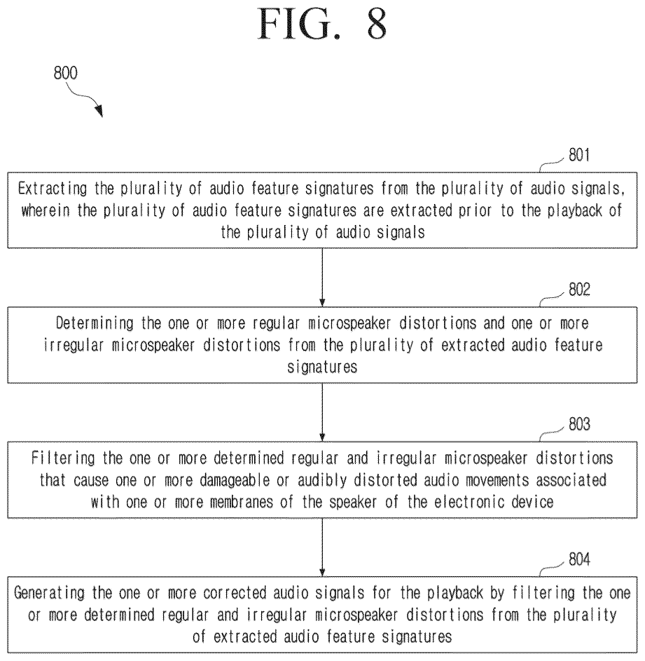

FIG. 8 is a flow diagram illustrating a method 800 for managing the speaker damage, according to an embodiment.

At operation 801, the method 800 includes extracting, by the feature extraction module 121, the plurality of audio feature signatures from the plurality of audio signals. The plurality of audio feature signatures are extracted prior to the playback of the plurality of audio signals.

At operation 802, the method 800 includes determining, by the distortion classification module 122, the one or more regular microspeaker distortions and one or more irregular microspeaker distortions from the plurality of extracted audio feature signatures.

At operation 803, the method 800 includes filtering, by the correction module 123, the one or more determined regular and irregular microspeaker distortions that cause one or more damageable or audibly distorted audio movements associated with one or more membranes of the speaker of the electronic device.

At operation 804, the method 800 includes generating, by the correction module 123, the one or more corrected audio signals for the playback by filtering the one or more determined regular and irregular microspeaker distortions from the plurality of extracted audio feature signatures.

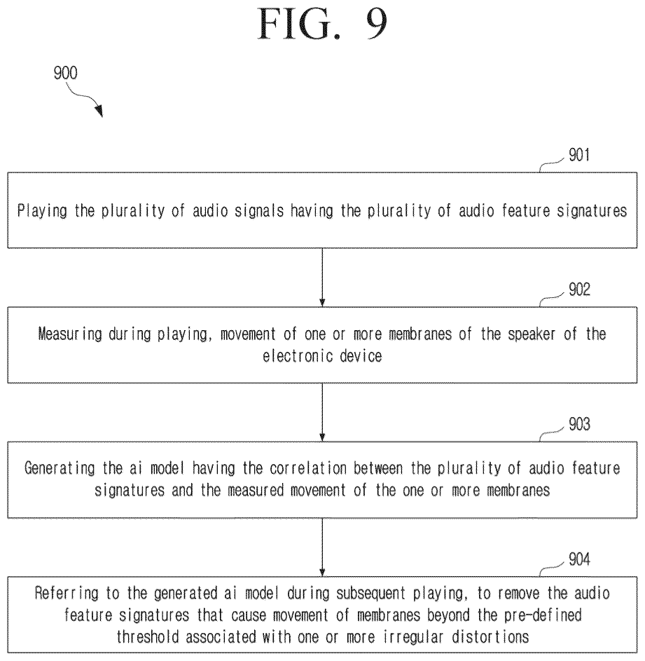

FIG. 9 is a flow diagram illustrating a method 900 for managing the speaker damage, according to another embodiment.

At operation 901, the method includes playing the plurality of audio signals having the plurality of audio feature signatures. At operation 902, the method includes measuring during playing, movement of one or more membranes of the speaker 140 of the electronic device 100. At operation 903, the method includes generating the AI model having the correlation between the plurality of audio feature signatures and the measured movement of the one or more membranes. At operation 904, the method includes referring to the generated AI model during subsequent playing, to remove the audio feature signatures that cause movement of membranes beyond the pre-defined threshold associated with one or more irregular distortions.

The various actions, acts, blocks, steps, or the like in the flow diagrams may be performed in the order presented, in a different order, or simultaneously. Further, in one or more embodiments, some of the actions, acts, blocks, steps, or the like may be omitted, added, modified, skipped, or the like without departing from the scope of the disclosure.

One more embodiments of the disclosure may provide one or more advantages over the existing excursion control mechanism, which are stated below.

Enhances bass, loudness, and overall sound quality of sound playback.

Eliminates the need for hardware for current/voltage sensing.

Does not necessitate hand-tuning of physical model parameters.

Utilizes the psychoacoustic model to eliminate perceptually insignificant signal segments from the signal, reducing computational complexity and enhancing the overall micro-speaker efficiency.

The proposed excitation control accounts for both regular and irregular non-linear speaker behavior.

Audible distortion measured using the microphone 150 can provide a more accurate real-time estimate of the target excursion levels compared to existing approaches that use pre-defined parameters (e.g., linear filtering).

The equalization filter (EQ) implemented with the psychoacoustic model provides a low-complexity speaker excursion control approach for ultra-low latency audio applications, such as gaming.

Unless otherwise defined, all technical and scientific terms used herein have the same meaning as commonly understood by one ordinary skilled in the art to which this disclosure belongs. The system, methods, and examples provided herein are illustrative only and not intended to be limiting.

While specific language has been used to describe the present subject matter, any limitations arising on account thereto, are not intended. As would be apparent to a person in the art, various working modifications may be made to the method to implement the one or more embodiments as taught herein. The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment.

The embodiments disclosed herein can be implemented using at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of certain example embodiments, those skilled in the art will recognize that the embodiments herein can be practiced with modification within the scope of the embodiments as described herein.

What is claimed is:

1. A method for managing speaker damage in an electronic device, the method comprising:
extracting a plurality of audio feature signatures from a plurality of audio signals, wherein the plurality of audio feature signatures are extracted prior to a playback of the plurality of audio signals by the electronic device;
identifying a regular microspeaker distortion and an irregular microspeaker distortion from the plurality of audio feature signatures, wherein the regular microspeaker distortion and the irregular microspeaker distortion are capable of causing one or more damageable or audibly distorted audio movements associated with one or more membranes of a speaker of the electronic device if output by the speaker; and
generating a corrected audio signal for the playback by filtering the regular and the irregular microspeaker distortions from the plurality of audio feature signatures.

2. The method of claim 1, wherein the extracting the plurality of audio feature signatures from the plurality of audio signals comprises:
determining one or more characteristics of each of the plurality of audio signals, wherein the one or more characteristics of each of the plurality of audio signals comprises at least one of a stationary signal, a quasi-stationary signal, or a transient signal;
segmenting, based on the one or more characteristics, the plurality of audio signals; and
extracting, using at least one of a transformation mechanism, a type of transformation, a filter-bank mechanism, or a neural network based dimensionality reduction mechanism, the plurality of audio feature signatures from each segment, wherein the plurality of audio feature signatures comprises at least one of a power spectrum density, a root mean square (RMS) value, or a peak value of a signal.

3. The method of claim 2, wherein the identifying the regular microspeaker distortion and the irregular microspeaker distortion from the plurality of audio feature signatures comprises:
comparing the plurality of audio feature signatures with a plurality of reference audio feature signatures, wherein the plurality of reference audio feature signatures are previously extracted from one or more audio signals that are free from the regular microspeaker distortion and the irregular microspeaker distortion; and
based on the result of the comparing, determining whether the plurality of audio feature signatures includes the regular microspeaker distortion and the irregular microspeaker distortion,
wherein the comparing is performed using a model trained using at least one of measured excursion data or measured acoustic data.

4. The method of claim 1, further comprising:
determining one or more parameters associated with the electronic device, wherein the one or more parameters comprise at least one of application characteristic information, target audio application information, audio content information, processing capability information, or available computational resource information; and
selecting, based on the one or more parameters, a neural network based mechanism or a digital signal processing (DSP) based mechanism to perform the identifying the regular microspeaker distortion and the irregular microspeaker distortion.

5. The method of claim 4, wherein the generating the corrected audio signal for the playback further comprises:
performing, based on the regular microspeaker distortion and the irregular microspeaker distortion, waveform correction on the plurality of audio signals by utilizing at least one of an equalization filter based modification mechanism, a neural network based modification mechanism, or a stochastic based processing mechanism; and
generating, based on the waveform correction, the corrected audio signal for the playback.

6. The method of claim 5, further comprising:
determining a maximum speaker displacement value associated with the plurality of audio signals using a regression model; and
improving an accuracy of at least one of the equalization filter based modification mechanism, the neural network based modification and the stochastic based processing mechanism based on the maximum speaker displacement value.

7. The method of claim 1, wherein the extracting the plurality of audio feature signatures further comprises:
determining one or more characteristics of each of the plurality of audio signals, wherein the one or more characteristics of each of the plurality of audio signals comprises at least one of a stationary signal, a quasi-stationary signal, or a transient signal;
segmenting the plurality of audio signals based on the one or more characteristics of each of the plurality of audio signals;
extracting, using at least one of a transformation mechanism, a filter-bank mechanism, or a neural network based dimensionality reduction mechanism, the plurality of audio feature signatures from each of the plurality of audio signals, wherein the plurality of audio feature signatures comprises at least one of a power spectrum density, a root mean square value, or a peak value;
comparing the plurality of audio feature signatures from each of the plurality of audio signals with the a plurality of reference audio feature signatures, wherein the plurality of reference audio feature signatures are previously extracted from one or more audio signals that are free from the regular microspeaker distortion and the irregular microspeaker distortion;
based on the result of the comparison, determining one or more probability scores and one or more confidence intervals;
validating the one or more probability scores and the one or more confidence intervals using manually labeled data, and
based on a result of validation, selecting a feature extraction method.

8. The method of claim 1, further comprising performing at least one of:
extracting, from the plurality of audio signals, one or more signal segments that cause the regular microspeaker distortion and the irregular microspeaker distortion, or
extracting the plurality of audio feature signatures that cause the regular microspeaker distortion and the irregular microspeaker distortion.

9. The method of claim 1, further comprising:
training a regular neural network module, based on the regular microspeaker distortion and target audio data without the regular microspeaker distortion, to generate a first control signal feature, and
training an irregular neural network module, based on the irregular microspeaker distortion and target audio data without the irregular microspeaker distortion, to generate a second control signal feature.

10. A system for managing speaker damage in an electronic device, the system comprising:
memory storing one or more instructions;
a communicator;
a speaker;
a microphone; and
at least one processor configured to execute the one or more instructions,
wherein the one or more instructions, when executed by the at least one processor, cause the system to:
extract a plurality of audio feature signatures from a plurality of audio signals, wherein the plurality of audio feature signatures are extracted prior to a playback of the plurality of audio signals,
identify a regular microspeaker distortion and an irregular microspeaker distortion from the plurality of audio feature signatures, wherein the regular microspeaker distortion and the irregular microspeaker distortion are capable of causing one or more damageable or audibly distorted audio movements associated with one or more membranes of the speaker if output by the speaker, and
generate a corrected audio signal for the playback by filtering the regular and the irregular microspeaker distortions from the plurality of audio feature signatures.

11. The system of claim 10, wherein the one or more instructions, when executed by the at least one processor, cause the system to extract the plurality of audio feature signatures from the plurality of audio signals by:
determining one or more characteristics of each of the plurality of audio signals, wherein the one or more characteristics of each of the plurality of audio signals comprises at least one of a stationary signal, a quasi-stationary signal, or a transient signal,
segmenting, based on the one or more characteristics, the plurality of audio signals, and
extracting, using at least one of a transformation mechanism, a type of transformation, a filter-bank mechanism, or a neural network based dimensionality reduction mechanism, the plurality of audio feature signatures from each segment, wherein the plurality of audio feature signatures comprises at least one of a power spectrum density, a root mean square (RMS) value, or a peak value of a signal.

12. The system of claim 11, wherein the one or more instructions, when executed by the at least one processor, cause the system to identify the regular microspeaker distortion and the irregular microspeaker distortion from the plurality of audio feature signatures by:
comparing the plurality of audio feature signatures from a current segment with a plurality of reference audio feature signatures, wherein the plurality of reference audio feature signatures are previously extracted from one or more audio signals that are free from the regular microspeaker distortion and the irregular microspeaker distortion, and
based on the result of the comparison, determining whether the plurality of audio feature signatures includes the regular microspeaker distortion and the irregular microspeaker distortion,
wherein the comparing is performed using a model trained using at least one of measured excursion data or measured acoustic data.

13. The system of claim 10, wherein the one or more instructions, when executed by the at least one processor, cause the system to:
determine one or more parameters associated with the electronic device, wherein the one or more parameters comprise at least one of application characteristic information, target audio application information, audio content information, processing capability information, or available computational resource information, and
select, based on the one or more parameters, a neural network based mechanism or a digital signal processing based mechanism to perform the identifying of the regular microspeaker distortion and the irregular microspeaker distortion.

14. The system of claim 13, wherein the one or more instructions, when executed by the at least one processor, cause the system to generate the corrected audio signal for the playback by:
performing, based on the regular microspeaker distortion and the irregular microspeaker distortion, waveform correction on the plurality of audio signals by utilizing at least one of an equalization filter based modification mechanism, a neural network based modification mechanism, or a stochastic based processing mechanism, and
generating, based on the waveform correction, the corrected audio signal for the playback.

15. A non-transitory computer readable medium having instructions stored therein, which when executed by at least one processor cause the at least one processor to execute a method for managing speaker damage in an electronic device, the method comprising:
extracting a plurality of audio feature signatures from a plurality of audio signals, wherein the plurality of audio feature signatures are extracted prior to a playback of the plurality of audio signals by the electronic device;
identifying a regular microspeaker distortion and an irregular microspeaker distortion from the plurality of audio feature signatures, wherein the regular microspeaker distortion and the irregular microspeaker distortion are capable of causing one or more damageable or audibly distorted audio movements associated with one or more membranes of a speaker of the electronic device if output by the speaker; and
generating a corrected audio signal for the playback by filtering the regular and the irregular microspeaker distortions from the plurality of audio feature signatures.

16. The non-transitory computer readable medium of claim 15, wherein the extracting the plurality of audio feature signatures from the plurality of audio signals further comprises:
determining one or more characteristics of each of the plurality of audio signals, wherein the one or more characteristics of each of the plurality of audio signals comprises at least one of a stationary signal, a quasi-stationary signal, or a transient signal;
segmenting, based on the one or more characteristics, the plurality of audio signals; and
extracting, using at least one of a transformation mechanism, a type of transformation, a filter-bank mechanism, or a neural network based dimensionality reduction mechanism, the plurality of audio feature signatures from each segment, wherein the plurality of audio feature signatures comprises at least one of a power spectrum density, a root mean square value, or a peak value of a signal.

17. The non-transitory computer readable medium of claim 15, wherein the identifying the regular microspeaker distortion and the irregular microspeaker distortion from the plurality of audio feature signatures comprises:
comparing the plurality of audio feature signatures with a plurality of reference audio feature signatures, wherein the plurality of reference audio feature signatures are previously extracted from one or more audio signals that are free from the regular microspeaker distortion and the irregular microspeaker distortion; and
based on the result of the comparison, determining whether the plurality of audio feature signatures includes the regular microspeaker distortion and the irregular microspeaker distortion,
wherein the comparing is performed using a model trained using at least one of measured excursion data or measured acoustic data.

18. The non-transitory computer readable medium of claim 15, wherein the extracting the plurality of audio feature signatures further comprises:
determining one or more characteristics of each of the plurality of audio signals, wherein the one or more characteristics of each of the plurality of audio signals comprises at least one of a stationary signal, a quasi-stationary signal, or a transient signal;
segmenting the plurality of audio signals based on the one or more characteristics of each of the plurality of audio signals;
extracting, using at least one of a transformation mechanism, a filter-bank mechanism, or a neural network based dimensionality reduction mechanism, the plurality of audio feature signatures from each of the plurality of audio signals, wherein the plurality of audio feature signatures comprises at least one of a power spectrum density, a root mean square (RMS) value, or a peak value;
comparing the plurality of audio feature signatures from each of the plurality of audio signals with the a plurality of reference audio feature signatures, wherein the plurality of reference audio feature signatures are previously extracted from one or more audio signals that are free from the regular microspeaker distortion and the irregular microspeaker distortion;
based on the result of the comparison, determining one or more probability scores and one or more confidence intervals;
validating the one or more probability scores and the one or more confidence intervals using manually labeled data, and
based on a result of validation, selecting a feature extraction method.

19. The non-transitory computer readable medium of claim 15, wherein the method further comprises performing at least one of:
extracting, from the plurality of audio signals, one or more signal segments that cause the regular microspeaker distortion and the irregular microspeaker distortion, or
extracting the plurality of audio feature signatures that cause the regular microspeaker distortion and the irregular microspeaker distortion.

20. The non-transitory computer readable medium of claim 15, wherein the method further comprises:
training a regular neural network module, based on the regular microspeaker distortion and target audio data without the regular microspeaker distortion, to generate a first control signal feature, and
training an irregular neural network module, based on the irregular microspeaker distortion and target audio data without the irregular microspeaker distortion, to generate a second control signal feature.
